(19) United States
(12) Patent Application Publication
(10) Pub. No.: US 2015/0371335 A1
(43) Pub. Date: Dec. 24, 2015

(54) Business Financing Method and System

(71) Applicant: ZIP CODE CAPITAL, INC, Rancho Santo Fe, CA (US)

(72) Inventors: Vincent P Liptak, Carmel, IN (US); Evan Malter, Rancho Santa Fe, CA (US)

(73) Assignee: Zip Code Capita, Inc, Rancho Santa Fe, CA (US)

(21) Appl. No.: 14/765,397

(22) PCT Filed: Jan. 31, 2014
(86) PCT No.: PCT/US2014/014006

§ 371 Date: Aug. 3, 2015

Related U.S. Application Data
(60) Provisional application No. 61/807,318, filed on Apr. 2, 2013.
(60) Provisional application No. 61/760,034, filed on Feb. 2, 2013.

(51) Int. Cl. G06Q 40/06

(52) U.S. Cl. CPC G06Q 40/06

(57) ABSTRACT

Methods and systems for transacting business financing are described. Such methods and systems may involve businesses, providers of capital, and consumers in a transaction that provides fully collateralized financial instruments for the purpose of funding a business.

### FIELD

One or more embodiments of this disclosure relate to systems and methods for providing financing to businesses in need of capital. More particularly, certain aspects of this disclosure are directed to small business financing options, such as loans.

### BACKGROUND

Small businesses in the category of “mom and pop” establishments have a more difficult time raising capital through traditional channels than do large companies. Historically, small independent businesses were not candidates for the public offering of stock, and were not good candidates to raise capital through private offerings under Regulation D. Typical small businesses in this category have relied on funding vehicles such as bank loans, SBA loans, government grants, home equity loans of the owners, loans from friend and family, or more recently merchant cash advances (MCAs) to meet their immediate capital needs. Recent macroeconomic events have created an environment in which access to credit and loans has changed dramatically for small businesses and small business owners. Tightened lending practices have made it harder for small businesses to obtain loans. As a result of the risks and challenges described above, there is a significant need for providing new options for small businesses to obtain funding.

### SUMMARY

Certain embodiments of this disclosure relate generally to networks, devices, methods and computer-readable medium for facilitating capital lending based on consumer promises. Such networks, devices, methods and computer-readable medium may determine a total cash value of promises by consumers to buy one or more goods or services offered by a business. The total cash value may be used to determine an amount of capital a lender will lend to the business. Payments the lender will receive from the business in exchange for lending the amount of capital to the business may also be determined.

### DRAWINGS

FIG. 1 diagrams interaction of participants of an embodiment.

FIG. 2 depicts logical elements of an embodiment as it pertains to a business.

FIG. 3 depicts the logical elements of an embodiment as it pertains to a consumer.

FIG. 4 depicts logical elements of an embodiment as it pertains to a consumer.

FIG. 5 depicts logical elements of an embodiment as it pertains to a capital provider.

FIG. 6 depicts logical elements of an embodiment as it pertains to a business.

FIG. 7 diagrams a process flow of an embodiment.

### DETAILED DESCRIPTION

Unless defined otherwise, all technical and scientific terms used herein have the same meaning as commonly understood by one of ordinary skill in the art to which at least some embodiments belongs. The following terms may, depending on the embodiment, refer to the following definitions. However, it is understood that these definitions are only examples of the particular terms. One of skill in the art will appreciate alternative definitions as known in the art. Although any methods and materials similar or equivalent to those described herein can also be used in the practice or testing of at least some embodiments, a limited number of the exemplary methods and materials are described.

The term “capital” may include “financial capital” as understood by those of skill in the art as any liquid medium or mechanism that represents wealth or other styles of capital, or “real capital” as understood by those of skill in the art as physical goods that assist in the production of other goods and services. Preferably, “capital” may include purchasing power in the form of cash money or credit.

The term “consumer” may include individual or entity that purchases or may purchase goods or services from a business.

The term “financial instruments” may include any manner of transferring a financial interest or obligation from one party to another. Examples of financial instruments include but are not limited to any note, stock, treasury stock, security future, security-based swap, bond, debenture, evidence of indebtedness, certificate of interest or participation in any profit-sharing agreement or in any oil, gas, or other mineral royalty or lease, any collateral-trust certificate, preorganization certificate or subscription, transferable share, investment contract, voting trust certificate, certificate of deposit for a security, any put, call, straddle, option, or privilege on any security, certificate of deposit, group or index of securities (including any interest therein or based on the value thereof), any put, call, straddle, option, or privilege entered into on a national securities exchange relating to foreign currency, commercial paper, line of credit, note which has a maturity at the time of issuance of not exceeding nine months, exclusive of days of grace, or any renewal thereof the maturity of which is likewise limited; draft which has a maturity at the time of issuance of not exceeding nine months, exclusive of days of grace, or any renewal thereof the maturity of which is likewise limited; bill of exchange which has a maturity at the time of issuance of not exceeding nine months, exclusive of days of grace, or any renewal thereof the maturity of which is likewise limited; or banker's acceptance which has a maturity at the time of issuance of not exceeding nine months, exclusive of days of grace, or any renewal thereof the maturity of which is likewise limited; any fully collateralized debt instrument (such as a loan, promissory note, receivables assignment, and the like); any commercial loan; a note delivered in consumer financing; a note secured by a mortgage on a home; a note secured by a lien on a small business or some of its assets; a note relating to a “character” loan to a bank customer; a note which formalizes an open-account indebtedness incurred in the ordinary course of business; a short-term note (eg a promissory note) secured by an assignment of accounts receivables; a note given in connection with loans by a commercial bank to a business for current operations; or a cash advance given in exchange for an assignment of future sales, membership dues paid by customers, and the like. Any financial instrument as used herein may or may not be a security as defined by the Securities Exchange Act of 1933 or the Securities Exchange Act of 1934. Preferably, a financial instrument can be any manner of transferring a financial interest or obligation from one party to another that does not qualify as a security. More preferably, a financial instrument can be any line of credit; a note which has a maturity at the time of issuance of not exceeding nine months, exclusive of days of grace, or any renewal thereof the maturity of which is likewise limited; a draft which has a maturity at the time of issuance of not exceeding nine months, exclusive of days of grace, or any renewal thereof the maturity of which is likewise limited; a bill of exchange which has a maturity at the time of issuance of not exceeding nine months, exclusive of days of grace, or any renewal thereof the maturity of which is likewise limited; or banker's acceptance which has a maturity at the time of issuance of not exceeding nine months, exclusive of days of grace, or any renewal thereof the maturity of which is likewise limited; any fully collateralized debt instrument (such as a loan, note, or the like); any commercial loan; a note delivered in consumer financing; a note secured by a mortgage on a home; a note secured by a lien on a small business or some of its assets; a note which formalizes an open-account indebtedness incurred in the ordinary course of business; or a note (eg a promissory note) given in connection with loans by a commercial bank to a business for current operations. More preferably, a financial instrument can be any line of credit; note which has a maturity at the time of issuance of not exceeding nine months, exclusive of days of grace, or any renewal thereof the maturity of which is likewise limited; or any fully collateralized debt instrument (such as a loan, note, or the like). More preferably, a financial instrument can be any fully collateralized loan or a note (eg a promissory note) that has a maturity at the time of issuance of not exceeding nine months, exclusive of days of grace, or any renewal thereof the maturity of which is likewise limited. More preferably, a financial instrument can be a loan. More preferably, a financial instrument can be a cash advance as defined herein. More preferably, a financial instrument can be a sale or assignment of an accounts receivable.

The term “loyalty program” may include any arrangement between a consumer and a business in which the consumer receives any kind of reward or discount from one or more participating businesses. A loyalty program can be a program in which a consumer signs up or registers for the program through an online form, over the phone, over email, at the business, and the like. A loyalty program can offer a discount, such as 5% off of goods or services, a cash back bonus, such as 5% cash back to the consumer upon the purchase of goods or services, points for use in additional purchases or to receive additional discounts, rewards, such as free goods or services, and the like.

The term “offer to provide capital” may include any offer related to the exchange of cash for any financial instrument, as defined herein, whether such offer be made verbally, by mails, by email, over the internet, through a web portal, or by any other may include possible for communicating such offer to a business or other recipient of such offer. Preferably, an offer to provide capital may include any offer to exchange cash for any financial instrument, as defined herein, that does not qualify as a security. Preferably, an offer to provide capital is an offer to exchange cash for a security. More preferably, an offer to provide capital may include any offer to exchange cash for any line of credit; a note which has a maturity at the time of issuance of not exceeding nine months, exclusive of days of grace, or any renewal thereof the maturity of which is likewise limited; a draft which has a maturity at the time of issuance of not exceeding nine months, exclusive of days of grace, or any renewal thereof the maturity of which is likewise limited; a bill of exchange which has a maturity at the time of issuance of not exceeding nine months, exclusive of days of grace, or any renewal thereof the maturity of which is likewise limited; a banker's acceptance which has a maturity at the time of issuance of not exceeding nine months, exclusive of days of grace, or any renewal thereof the maturity of which is likewise limited; any fully collateralized debt instrument (such as a loan, note, or the like); any commercial loan; a note delivered in consumer financing; a note secured by a mortgage on a home; a note secured by a lien on a small business or some of its assets; a note relating to a “character” loan to a bank customer; a note which formalizes an open-account indebtedness incurred in the ordinary course of business; short-term notes secured by an assignment of accounts receivables; a note given in connection with loans by a commercial bank to a business for current operations; or the sale or assignment of one or more accounts receivable. More preferably, an offer to provide capital may include any fully collateralized loan, or a note that has a maturity at the time of issuance of not exceeding nine months, exclusive of days of grace, or any renewal thereof the maturity of which is likewise limited. More preferably, an offer to provide capital may include any offer to exchange cash for any sale or assignment of one or more accounts receivable.

The term “offer to sell goods or services” may include any advertisement, billboard, internet website, internet posting, verbal offer, or written offer in which a business displays or otherwise conveys goods or services for sale to any person or entity.

The term “over a predetermined amount of time” may include an expiration date of a pre-paid card, a membership term, or any other time period measurement for the value of the promise to be usable for the purchase of goods or services. The amount of time can be, for example, 3 months, 6 months, 9 months, 12 months, 18 months or unlimited. Preferably, a promise can be a membership having a predetermined amount of time of up to 12 months.

The term “promise” as it relates to a promise to purchase a predetermined amount of goods over a predetermined amount of time can be a membership, a pre-paid card, or a pledge to purchase goods or services in the future. As used herein, a “membership” can include a pre-paid membership, a membership contract having delayed fixed payments, a membership contract having delayed payments wherein the membership fee is taken out of future transactions, and the like. A membership can be tied to a loyalty program in the form of a “loyalty membership”. A loyalty membership can be a pre-paid membership, a membership contract having delayed fixed payments, a membership contract having delayed payments wherein the membership fee is taken out of future transactions, and the like. A loyalty membership can include all of the features of a loyalty program including, but not limited to, a discount, such as 5% off of goods or services, a cash back bonus, such as 5% cash back to the consumer upon the purchase of goods or services, points for use in additional purchases or to receive discounts or rewards—e.g., free goods/services.

The term “predetermined amount of goods or services” may include a fixed amount of goods or services (e.g. a fixed number of units purchased, a fixed number of hours of service, a fixed number of individual services, a fixed cost of the goods or services), a minimum amount of goods or services (e.g. a promise to purchase a minimum number of units purchased, a promise to purchase a minimum number of hours of service, or promise to purchase a minimum number of individual services, a promise to spend money on goods or services offered by a business), or an amount of goods and services within a range (e.g. 75-100 units, 25-30 hours of services, or 40-50 individual services, $1-$10,000). The term “amount” may refer to a number of units or a monetary value.

The term “provider of capital” or “advancer” may include any person or entity willing to give cash or any other form of currency. An entity can be a, for example, a hedge fund, a bank, a savings and loan, a stock fund, a credit union, a government, a government organization, a non-profit, a corporation, or any other institution that holds capital available for offer to a business. A provider of capital or advancer can be any person or entity willing to give capital for a return on investment (ROI). The ROI is based on a rate of return of the financial instrument chosen as the subject of the offer to provide capital. A rate of return can be determined by the appreciation of the value of the property exchanged for the capital (e.g. common stock), on an discount factor applied to the value of the property exchanged for the capital (e.g. a 10% discount on the purchase of accounts receivable to account for receivables aging, receivable non-payment risk, and the like), a fixed or variable interest rate (e.g. loan), or on a premium amount added to the value of the capital provided (e.g. the principal) based on a predetermined percentage premium (e.g. a 20% premium on receivables over the amount of capital requested by the small business). A provider of capital or advancer can be any person or entity willing to give capital for no return on investment (e.g. a charitable contribution). Preferably, a provider of capital or advancer is any person or entity willing to give capital for a return on investment (ROI) as described.

The term “request for capital” may include any request for capital made by a business in exchange for one or more financial instruments through any may include of communication including but not limited to an advertisement, billboard, internet website, internet posting, verbal offer, or written offer. Preferably, the business is a small business in need of capital.

The term “return” may include the appreciation of the value of the property exchanged for the capital (e.g. common stock), the discount factor applied to the value of the property exchanged for the capital (a 10% discount on the purchase of accounts receivable to account for receivables aging, receivable non-payment risk, and the like), the interest received based on a fixed or variable interest rate (e.g. a fixed or variable rate loan), or the premium amount charged between the value of the capital provided (e.g. the principal) and the actual amount of capital provided.

The term “small business in need of capital” may include any business having less than 500 employees in the manufacturing sector or less than $7 million in total receipt for the non-manufacturing sector that is in need of cash or financing for any business purpose including cash flow, to meet current debt obligations such as payroll, accounts payable, and the like; to meet future debt obligations such as payroll, accounts payable, and the like; expansion of the business; the purchase of new equipment or hard assets, and the like.

The term “user interface” may include any may include by which a user can interact with data or information. A user interface can be an electronic or computerized platform that is either hardware or software based such as a personal computer, a laptop computer, a mobile device, an app, a website, or a web portal. Examples of mobile devices include but are not limited to smartphones, tablets, personal data assistants (PDAs), cellular phones, and the like. Preferably, user interface may include a website, web portal or app. Preferably, a user interface is viewable through a personal computer, a laptop computer, or a mobile device. More preferably, user interface may include a website, web portal or app viewed through a personal computer, a laptop computer, or a mobile device.

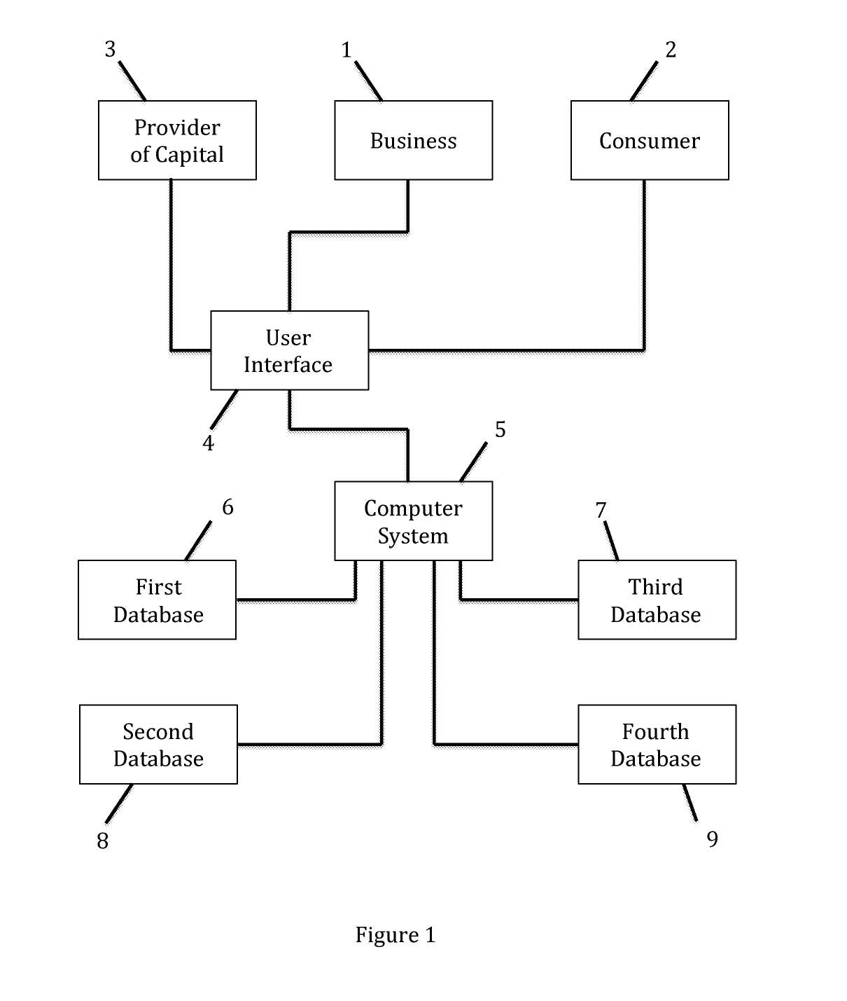

With reference to FIG. 1, the hardware and network components used in the implementation of at least some embodiments may now be described. Different embodiments may be intended for use by businesses seeking to raise capital and to sell their goods and services to consumers. The key participants may include the businesses (1), providers of capital (2), and consumers (3). All three participants engage with one or more user interfaces. In the embodiment described in FIG. 1, all three participants engage with a single user interface (4). The user interface can be used by the participants to make inputs (e.g. creating accounts, and entering data), to communicate with each other, to view information about requests for capital, to view information about returns (e.g. interest rates, premiums, and the like), to view information about promises to purchase goods or service, and the like. Of course, the single interface may be distributed as different interfaces for each user, and even different interfaces for the same user. The user interface is linked to a computer system (5) that is used, for example, to transfer participant data to databases, for processing payments and capital transfers, for calculating rates of return (e.g., interest rates) based on a variety of information including, but not limited to, age, credit history, financial history, and the ratio of the cash value of promises received through the user interface to support the request for capital as collateral to the cash value of the capital request.

The computer system (5) is linked to several databases. In FIG. 1, the computer system is linked to four databases. In this embodiment, the first database (6) is used for storing information about each of a plurality of businesses, a request for capital made by each of said plurality of businesses, and offers by said businesses to sell goods or services. The first database can be used to store all information regarding the businesses that create business accounts on the user interface. Such information can also include biographical information about the business owners, background data about the business, marketing information and materials geared toward consumers (e.g. videos, product information, business information, information on discounts or benefits that consumers could receive by promising to buy goods or services, and the like), information and materials geared toward consumers (e.g. videos, product information, business information, financial documents, financial projections, sales projections, and the like). The data on the first database can be accessed by the computer system (5), displayed on the user interface, and continually updated as the business associated with that data modifies their account.

In the embodiment described in FIG. 1, the second database (7) is used for storing information about each of a plurality of consumers and promises made by each of said plurality of consumers. The second database (7) can be used to store all information regarding the consumers that create consumer accounts on the user interface. Such information includes information on promises to purchase a predetermined amount of goods or services from at least one of said businesses over a predetermined amount of time. Such information can also include biographical information about the consumers, social networking information, spending information about the consumers, payment history, survey data submitted by the consumers, comments posted by the consumers, prior promises to other businesses made by the consumers, and the like. The data on the second database can be accessed by the computer system (5), displayed on the user interface, and continually updated as the consumer associated with that data modifies their account.

In FIG. 1, the third database (8) is used for storing information about each of a plurality of providers of capital and offers to provide capital to at least one of the businesses on the user interface. Such information can also include biographical information about the providers, social networking information, survey data submitted by the providers, comments posted by the providers, prior investments to other businesses made by the consumers through the user interface, and the like. The data on the third database can be accessed by the computer system (5), displayed on the user interface, and continually updated as the provider associated with that data modifies their account.

In FIG. 1, the fourth database (9) is used for storing information about financial instruments issued by each of the plurality of businesses in consideration for capital provided by the providers of capital. Where the computer system (5) is used to calculate, for example, an interest rate using an algorithm that includes a step of calculating a ratio of a total cash value of promises to a cash value of a request for capital to determine a level of risk of the request for capital to the provider(s) of capital, the fourth database is where all of the data associated with the calculation and the outcome of the calculation is stored. The information stored on this database can be accessed by the computer system (5) for the purpose of conducting further calculations as the relative level of promises received and offers to provide capital received changes throughout the funding campaign.

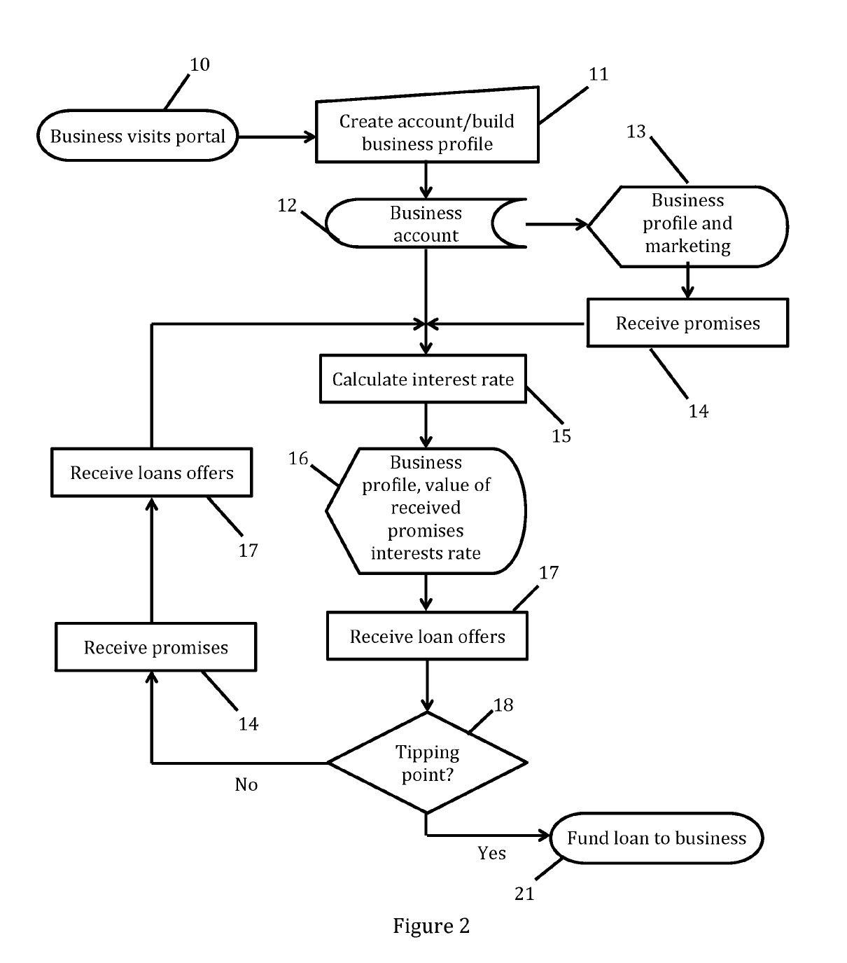

In at least some embodiments, each of the businesses, providers of capital and consumers visiting the user interface (e.g. web portal) will have common experiences, as well as individualized experiences and data flows with the user interface, computer system and databases. For example, FIG. 2 describes one embodiment of the data flow/experience of a business visiting the user interface. In this embodiment, upon first arrival to the user interface, a business would create an account and build a business profile (11). The business profile can include but is not limited to information such as a description of the business, marketing videos related to the business, a request for capital, financial documents relevant to a request for capital, credit history information, past sales performance, sales projections, ownership structure, biographical information about owners, information about business location, target customer demographic information, tax records, and the like. While the embodiment shown in FIG. 2 shows the business creating a business account and building a business profile in the same process step, it will be understood that a business can create a business account and complete the business profile creation over a period of time and not at the time of the first visit to the user interface. In such a case, upon returning to the user interface, the business would login to the user interface accessing any data previously stored in their business account and complete further details regarding the business profile. The same is true of other steps. The complete data for a business account (12) is stored on one or more servers. Stored information from the business account is displayed on the user interface as business profile and marketing material (13) for consumers to view and make decisions about making promises to purchase goods or services form the business.

After a consumer makes the decision to promise to purchase goods or services from a business, the information related to the promises are received onto the computer system through the user interface (14). For example, the information may include an amount of money the consumer promises to transfer to the business (e.g., spend at the business) in exchange for the goods or services (including a gift card), a number of units of the goods or services, a time period during which the consumer promises to transfer the money to the business, and/or other information. In some embodiments, a cash value of each promise may be determined based on the amount of money (e.g., where the amount of money equals the cash value), or the number of goods or services (e.g., where a summed cost of the number of goods or services equals the cash value). The cash values of multiple promises from multiple consumers may be described as a total cash value of those promises.

In the embodiment shown in FIG. 2, the received promises are then included in the calculation of an interest rate (15). The calculated interest rate (15) can also be referred to as “calculate rate of return”. It will be understood by those skilled in the art that an interest rate calculation in the embodiment described in FIG. 2 can be completed either before the receipt of any promises from consumers, concurrent with the receipt of promises from consumers, or after the receipt of promises from consumers. In preferred embodiments, the calculation of a rate of return (e.g. an interest rate) can occur continuously from the moment a business completes a business profile (including making a request for capital) until the request for capital is fully collateralized by promises from consumers to purchase goods or services from the business. In the embodiment described in FIG. 2, after the interest rate is calculated (15) for the first time, the business profile, value of promises received and interest rate are then displayed on the user interface (16). In preferred embodiments, all of the information (13) and (16) is displayed on the same user interface (e.g. a web portal) and is viewable by all participants (e.g. businesses, consumers, and providers of capital) whether or not they are involved in a transaction. In another preferred embodiment, the user interface is a portal viewable by any of the participants through multiple platforms such as via a computer over an internet connection, on a mobile device using an app, or by an app on a tablet.

The transparent display of information is useful in allowing consumers and providers to decide whether a business is legitimate, how stable the business appears to be, and the likelihood that a fundraising campaign will be successful. The transparency also provides other benefits such as allowing consumers and providers to collectively decide whether the business appears to be a fraud or just won't work. In a further preferred embodiment, when the rate of return (e.g. an interest rate) is calculated continuously by the computer system, the display of the business profile and the rate of return (e.g. an interest rate) are also continuously updated on the user interface. The real-time nature of the displayed information relevant to at least some embodiments will allow providers to make investment decisions based on real market research data not available in most currently available financing models.

In the embodiment described in FIG. 2, the businesses receive loan offers (17) through the user interface based in part on the display of the promises received and the interest rate. One possible advantage of the embodiment described in FIG. 2 is that as promises are received and the interest rate is continuously updated, the interest rate available for a loan will adjust as well. As a result, a provider of capital who is interested in receiving a higher rate of return (i.e. a less risk averse/more risk tolerant investor) can choose to seek out businesses that have recently launched funding campaigns by receiving a higher interest rate on the portion of the loan they wish to fund (e.g. making an offer to provide capital before the business has accumulated a large number of promises to collateralize the loan and thus reduce the risk and the interest rate). In the alternative, a more risk averse/less risk tolerant provider of capital can choose to only seek out businesses that have received large numbers of promises from consumers which are applied as collateral to the loan amount, thus lowering the risk and the interest rate. In some embodiments, a total loan amount to a business may include a loan amount secured for a higher interest rate based on a first amount of promises, and another loan amount secured for a lower interest rate based on a second amount of promises. Once a first loan amount is secured for a first rate, a second rate for the remaining loan amount may be based not only on customer promises, but also on the first loan amount. The second rate may be based on a total number of promises, or promises made beyond those that were used to compute the first rate. The business may also set a maximum interest rate that the business will accept to insure a loan amount cannot be offered until the interest rate falls below that maximum interest rate.

Priority of return payment may also be determined depending on the relative timing of each loan, the relative amounts of the loans or other factors.

Throughout the funding campaign described in FIG. 2, the computer system will monitor the levels of offers to provide capital and promises to purchase goods or services to determine whether a tipping point is reached. The tipping point is a predetermined level of the offers to provide capital and promises to purchase goods or services past which a loan is guaranteed to fund. The tipping point can be based on reaching the total request for capital, reaching a minimum percentage of the request for capital received (e.g. offers to provide capital totaling to 80% of the total value of the request for capital), reaching a minimum percentage of a set amount of promises received (e.g. promises to purchase goods or services totaling 80% of a target amount of goods or services), a ratio of the promises to purchase goods received to offers to provide capital (e.g. a ratio of promises to purchase goods received to offers to provide capital of 2:1 could guarantee loan funding), or a combination thereof (such as if the request for capital has received offers to provide capital totaling a minimum of 50% of the request for capital and the ratio of promises to purchase goods received to offers to provide capital is 1.5:1, then the loan will be guaranteed to fund). In one embodiment, the tipping point is equivalent to the request for capital (e.g., the event is all or nothing depending on whether enough offers to provide capital are reached to equal the request for capital). In one embodiment, the total of received offers to provide capital can be a percentage of the total value of the request for capital and does not need to equal the total request for capital for the loan to fund in an amount equal to the total of the offers to provide capital received. For example, a business makes a request for capital of $50,000 and the tipping point for the loan to fund is 50% of the request for capital. If the business receives $25,000 in offers to provide capital, then the loan is guaranteed to fund at whatever final level of offers to provide capital they receive up to the total request for capital. Thus in this example, if the business receives $35,000 in offers to provide capital, then the loan will fund at $35,000. In some embodiments, for a total amount of received offers that exceeds the request for capital, the business may select which offers it will take on as loans. In some embodiments, the entities that offered the loans may bid against each other by lowering their offered interest rates.

In one embodiment, the tipping point is related to both the total offers to provide capital received and the total promises to purchase goods or services received. For example, a business makes a request for capital of $50,000 and the tipping point is 50% of the request for capital with a 2:1 ratio of promises to purchase goods or services received to offers to provide capital. In this example, if a business receives offers to provide capital totaling $25,000 and receives promises to purchase goods or services totaling $50,000, then the loan will fund for the final amount of the offers to provide capital received by the end of the funding campaign that is collateralized by a ratio of promises to purchase goods or services received to offers to provide capital equal to 2:1. If the funding campaign in this example ends with promises to purchase goods or services totaling $50,000 and offers to provide capital totaling $25,000, then the loan will fund at $25,000. If, however, the funding campaign in this example ends with promises to purchase goods or services totaling $50,000 and offers to provide capital totaling $35,000, then the loan will fund still fund at $25,000 because the tipping point component of the ratio of 2:1 (promises to purchase goods or services received to offers to provide capital) was not maintained for offers to provide capital greater than $25,000. On the other hand, if the funding campaign in this example ends with only promises to purchase goods or services totaling $50,000 and offers to provide capital totaling $15,000, then the loan will not fund. At this point, the business can modify its request for capital in a new campaign, for example taking advantage of the consumer support already received through promises to purchase goods or services.

One possible advantage of at least some embodiments can be that the tipping points for requests for capital can be adjusted in a number of different ways depending on other factors related to the business. For example, high credit rating, good past financial performance, good credit history, strong customer base, can all be factors that could adjust the tipping point variables. It will be understood that the ratio of promises to purchase goods or services received to offers to provide capital is on a continuum, and can be any ratio between 0.100:1 and 100:1 depending on the other factors described relating to the business. Preferably, the ratio of promises to purchase goods or services received to offers to provide capital is on a continuum between 0.5:1 and 10:1. In some embodiments, the ratio of promises to purchase goods or services received to offers to provide capital is on a continuum between 0.5:1 and 5:1. In other embodiments, the ratio of promises to purchase goods or services received to offers to provide capital is 0.5:1, 0.75:1, 1:1, 1.25:1, 1.5:1, 1.75:1, 2:1, 2.25:1, 2.5:1, 2.75:1, or 3:1.

The variability of the ratios of promises to purchase goods or services received to offers to provide capital combined with other factors can determine the rate of return on an offer to provide capital. For example, a request for capital can be considered “fully collateralized” at a ratio of promises to purchase goods or services received to offers to provide capital of 0.5:1 if the business making the request for capital has a very high credit rating, strong customer base, very good financial history, and the like. On the other hand, in other circumstances, a request for capital may only be considered “fully collateralized” at a ratio of promises to purchase goods or services received to offers to provide capital of at least 2:1 depending on the condition of the business making the request. Accordingly, the tipping point ratio of promises to purchase goods or services received to offers to provide capital can be referred to as a “collateralization ratio”. In one embodiment of the embodiment described in FIG. 2, the collateralization point will be a ratio of at least 2:1. A high degree of collateral supporting a request for capital can be advantageous in that a promissory note defining the loan made in the transaction may not be considered a security and thus would not be subject to SEC regulation.

In one embodiment, the tipping point will require that the request for capital be reached by offers to provide capital, and the collateralization ratio is maintained. In one embodiment, if the request for capital is reached by offers to provide capital and the collateralization ratio is maintained, then the loan will fund. However, in one embodiment, if the request for capital is not reached by offers to provide capital or the collateralization ratio is not maintained, then the loan will not fund.

In the embodiment described in FIG. 2, if the business has not reached the tipping point, the loan will not fund and the business will receive promises (14) and receive loan offers (17) as needed until the tipping point decision (18) is answered in the affirmative. In one embodiment, a time limit for the funding campaign will be limited to a maximum amount of time. The time limit can be very flexible and can be any length of time between 1 day and 200 days (e.g. 1 day, 1.5 days, 2 days, 2.25 days, 5, days, 10 days, 11 days, 12, days, 13 days, 14 days, 15 days, 25 days, 50 days, 60 days, 90 days, and the like). Alternatively, the time limit may extend or reset the time limit upon various conditions (e.g., n promises are made, m loan amount is offered). Where a time limit can extend or reset, entities that offer loans may make their loan offer expire at some point in time, may set modifications to their offer at some point in time.

In one embodiment, the length of a funding campaign is between 1 day and 60 days. In another preferred embodiment, the length of a funding campaign is between 1 day and 30 days. In another preferred embodiment, the length of a funding campaign is between 10 day and 30 days. In one embodiment, the length of a funding campaign is no longer than 45 days. In one embodiment, the length of a funding campaign is no longer than 30 days. In the embodiment described in FIG. 2, if the time limit is reached before the tipping point is reached, the request for capital will not fund.

Limiting the time of a funding campaign may have several possible advantages. One is providing certainty for providers of capital (e.g. lenders in the embodiment described in FIG. 2) to know when the offer they made will either fund or not. The amount of time remaining in a funding campaign can allow providers of capital to decide whether the business is likely to reach the tipping point, decide whether or not to make an offer, know exactly when their capital will be available for another offer, and the like. In some embodiments, entities that offer loans may set an original or additional loan amount that is offered automatically after a condition is met (e.g., an aggregate amount of offered loan amounts is reached, a time period has been reached, customer promises have reached a certain level.) A second possible advantage may be providing the businesses with an idea of whether their request for capital is likely to fund. For example, if a small start-up business (e.g. a restaurant in a particular neighborhood of a city) sees very little activity from both consumers interested in supporting that type of business through promises to purchase, than the business may have some idea of whether the idea will be successful in the market. On the contrary, a small business may see a great deal of promises from consumers and offers from providers to validate their business idea. While it is possible to generate this type of market research, to be accurate that research is very time-consuming and very expensive. A possible advantage of at least some embodiments may be that a small business of the type described may not have the money to buy that research or the desire to take focus away from running or starting the business.

In at least some embodiments, a funding campaign will not automatically end if the tipping point is reached, but will end when the business chooses to execute the transaction after the tipping point is reached but no later than the time limit of the funding campaign. For example, in the embodiment described in FIG. 2 a business makes a request for capital of $30,000 with a tipping point of $25,000 and a 2:1 ratio of promises to purchase to offers to provide capital (e.g. offers to loan) with a time limit of 30 days. If the business receives promises to purchase and offers to provide capital (e.g. offers to loan) in excess of the tipping in 25 days, the loan will not fund until either the full $30,000 is offered to the business with the 2:1 ratio maintained or the 30 day time limit expires. A possible advantage of using the time limit as a final stopping point for a request for capital is that it may be possible for a business to receive far more offers of capital and far more promises to purchase goods or services than they expected. For example, a new business makes a request for capital of $50,000 with a tipping point of $40,000 and a collateralization ratio of 2:1 with a time limit of 30 days. If the business receives a great deal of support from consumers and receives $150,000 worth of promises to purchase goods or services by day 20, then using the 2:1 collateralization ratio, the business should be eligible to receive offers to provide capital totaling $75,000. In this example, if the time limit on the request for capital has not expired and the business has received more than $50,000 in offers to provide capital, then the business can be allowed to adjust the amount of the request for capital to a higher number (e.g. $75,000) because the collateralization ratio is met as a tipping point condition even at a higher request for capital. Alternatively, the business may select (i.e., shop) a subset of the loan offers.

Furthermore in this example, if the business continues to receive additional promises to purchase goods or services above $150,000 before the 30-day time limit expires, then the final total of offers to provide capital can be adjusted to be the maximum allowed by the collateralization ratio. In one embodiment, the final total of offers to provide capital that will be given to the business can be any amount higher than the original request for capital as long as a capitalization ratio is maintained.

In one embodiment, the tipping point will require that the request for capital be reached by offers to provide capital, and the collateralization ratio is maintained before or at the end of the time period for conduct the request for capital. In one embodiment, if the request for capital is reached by offers to provide capital and the collateralization ratio is maintained before or at the end of the time period, then the loan will fund. However, in one embodiment, if the request for capital is not reached by offers to provide capital or the collateralization ratio is not maintained before or at the end of the time period, then the loan will not fund. One of skill in the art will recognize that the example described in FIG. 2 can include features different from that described. For example, received promises (14) can be loyalty memberships purchased by consumers through the portal. In one embodiment, the loyalty memberships are sold to consumers by the portal and are owned by the portal. The loyalty memberships owned by the portal are accounts receivable of the portal. In this embodiment, the portal would receive offers to purchase accounts receivable from providers of capital. In another preferred embodiment, loyalty memberships are sold to consumers through the portal, and are owned by the business. Thus loyalty memberships owned by the business can be an accounts receivable of the business.

In one embodiment, a portal sells loyalty memberships to consumers where the loyalty memberships are specific to a particular small business. Using the loyalty memberships as accounts receivable, the portal can sell or assign the loyalty memberships to third party providers of capital. The capital received by the portal for the sale or assignment of the accounts receivable can then be used to offer a loan or an advance to the business to which the loyalty memberships are applicable. The provider of capital can purchase the accounts receivable to achieve a return on investment by applying a discount factor that considers components such as risk of non-payment of the accounts receivable, payment history on the accounts receivable, and the like. Alternatively, the provider of capital can purchase the accounts receivable while keeping no profit.

Likewise, in this example, the portal can offer a loan or advance to the business as a result of sale or assignment of accounts receivable resulting from loyalty memberships sold in relation to the business for a return on investment. In this case, the portal can earn a return by charging an interest rate on the loan, by charging closing costs or fees on the loan or advance, or charging a premium on the loan or advance. Alternatively, the portal can offer the loan or advance to the business for no profit. In such an example, the portal can earn its profit, for example, based on participation of consumers in a portal sponsored loyalty program or the sale of loyalty memberships to consumers.

One of skill in the art will readily appreciate that the portal could operate in a manner to act as an intermediary to facilitate the sale or assignment of an accounts receivable for a loyalty membership owned by the small business to a provider of capital. In such an example, the process of capital flowing from the provider of capital to the business and from the consumer to the provider of capital can be the same as that described above with the exception that capital may not flow through the portal. For example, capital can flow from the consumers joining a loyalty program on the business or purchasing a loyalty membership in the small business to the small business, and then to the providers of capital. In such an example, the providers of capital can enter into accounts receivables assignments or sales, facilitated by the portal, directly with the small business. In that example, capital can flow from the providers of capital to the business without passing through the portal and the repayment of the capital (plus any return built into the loan or advance) can flow directly from the small business to the providers of capital.

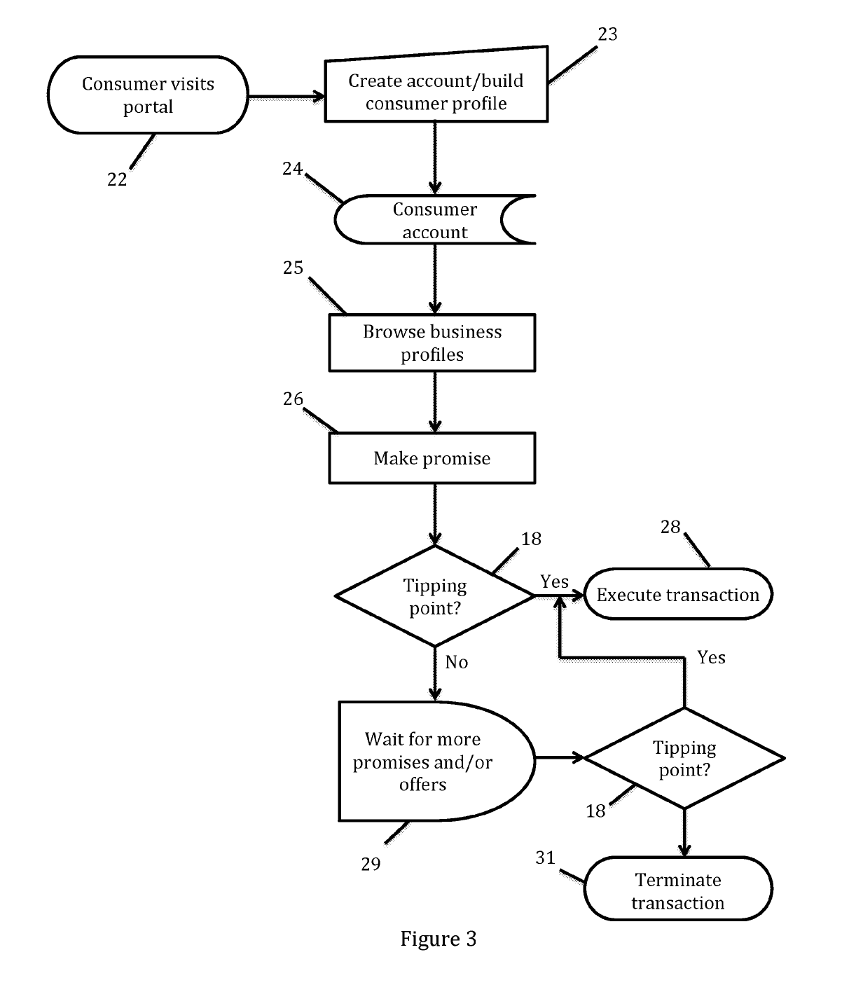

One of skill in the art will appreciate that the above examples describing the application of loyalty memberships as accounts receivable to obtain capital for businesses can be accomplished in other ways. For example, the account receivable owned by a business can be used as collateral for a security (e.g. a loan or a promissory note) for sale by the portal to the providers of capital. Alternatively, the small business can sell securities collateralized by accounts receivable with the portal acting as an intermediary designed to facilitate the transactions and lower the transaction costs for the providers of capital and the small business. Consumers visiting the user interface (e.g. web portal) will have certain experiences common to the businesses and providers of capital. And consumers visiting the user interface will have individualized experiences and data flows with the user interface, computer system and databases. For example, FIG. 3 describes one example of the data flow/experience of a consumer visiting the user interface. In this example, upon first arrival to the user interface, a consumer would create an account and build a consumer profile (23). The consumer profile can include but is not limited to information such as a personal information such location, age, gender, interests, and the like, a history of past promises to purchase from various businesses on the user interface, “friends” the consumer has connected with on the user interface, and comments the consumer has made on the user interface. The consumer profile can also contain information not publically viable on the user interface. Such information can include but is not limited to address, phone number, SSN, credit card information, bank information, and the like. Information the consumer profile inputs into the user interface while building a consumer profile is stored in a consumer account (24).

While the example shown in FIG. 3 shows the consumer creating a consumer account and building a consumer profile in the same process step, it will be understood that a consumer can create a consumer account and complete the consumer profile over a period of time and not at the time of the first visit to the user interface. The same is true of other steps. In such a case, upon returning to the user interface, the consumer would login to the user interface accessing any data previously stored in their consumer account and complete further details regarding the consumer profile. The complete data for a consumer account (23) is stored on one or more servers. Stored information from the consumer account is displayed on the user interface as a consumer profile.

In the example described in FIG. 3, the consumer then engages with the user interface to browse business profiles (25). Upon finding a business of interest, the consumer then makes a promise (26) to purchase goods or services from the business. If the tipping point decision (18) is affirmative after the consumer makes their promise to purchase goods or services, the transaction will execute (28). If after making a promise to purchase goods or services the tipping point decision (18) is not affirmative, the consumer will wait (29) for the request for capital campaign (e.g. wait for more offers to provide capital and/or promises to purchase goods or services) to reach the tipping point and/or ends. If the later tipping point decision (18) is affirmative, the transaction will execute (28). If the tipping point decision (18) is not affirmative, the transaction will not execute (31). In at least some embodiments, the tipping point decision (30) will coincide with the end of a pre-determined period of time for which the request for capital is open as described above.

In certain embodiments, the tipping point will have no impact on the consumer experience. Rather, the consumer experience with the portal will be based solely on time. For example, in some embodiments, after a business creates a business profile and begins marketing their campaign to customers to receive promises to purchase, a clock will start. For example, 7-10 days after creation of a business profile, the campaign to receive promises to purchase from customers will begin. The campaign can last, for example, for 10-30 days as predetermined by the business and/or the portal manager. At the end of the marketing campaign to receive promises to purchase, the rate of return will be calculated based on a variety of factors including the amount of promises to purchase received by the business. At this point in this example, the funding campaign will begin when the rate of return and total request for capital are displayed on the user interface (e.g. web portal). This part of the campaign can be open for a predetermined amount of time (e.g. 7-14 days). During the time in which a business is receiving offers to provide capital, the business can also be receiving additional promises to purchase. At the end of the funding campaign, the transactions for the promises can be executed and the promises applied as collateral for an amount of capital received by the business in a ratio consistent with a predetermined collateralization ratio. For example, if the business requested $25,000, received promises to purchase of $40,000, received offers to provide capital of $22,000, and set a collateralization ratio of 2:1 (promises to purchase : offers to provide capital), then the business would be eligible to receive $20,000 (half of $40,000, as determined by the 2:1 ratio). It will be understood that other embodiments exist in which transactions involving promises to purchase are not dependent on either the tipping point or time. Of course, transactions for the promises may be executed at the time of the promise (e.g., a charge on a credit card or transfer of money from a bank account of the consumer). The resultant transfer of funds may be held in trust, or otherwise reserved for availability when capital is loaned.

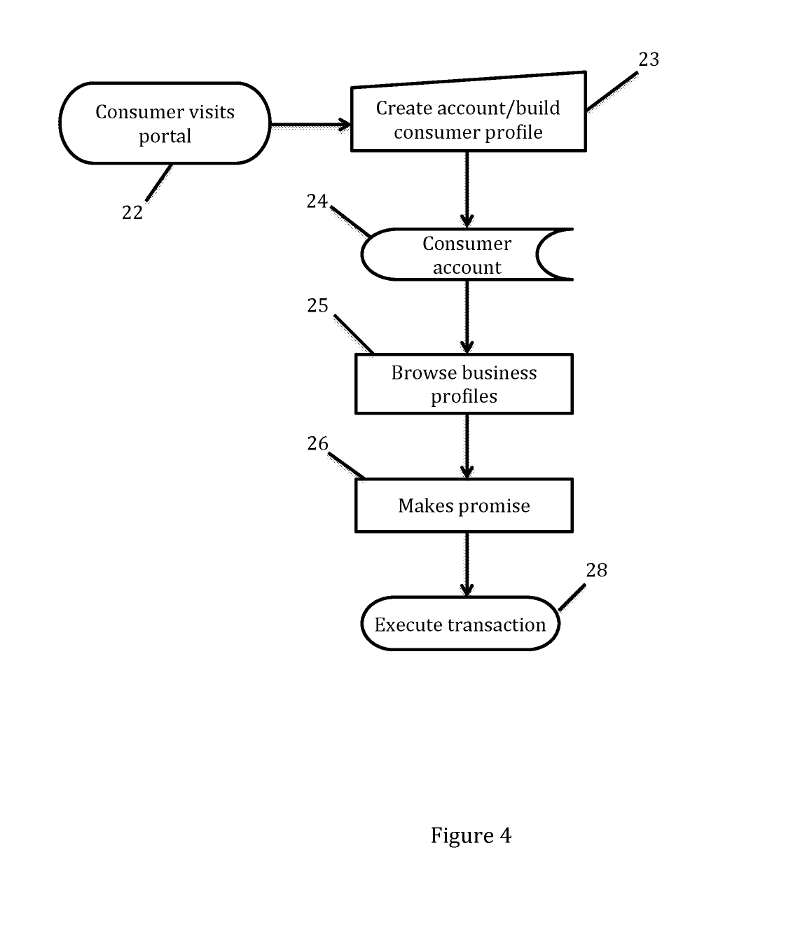

FIG. 4 describes another example of the data flow/experience of a consumer visiting the user interface. In this example, the consumer experience and data flow (22)-(26) are the same as in the example described in FIG. 3. In this example, the consumer's promise to purchase goods or services is not dependent on reaching a tipping point or on the value of offers to provide capital received by the business. In other words, when a consumer finds a business through the user interface that the consumer wants to support through a purchase, the promise to purchase is made and the transaction is executed (28). This transaction of a promise to purchase goods or services is independent of the offers to provide capital as a transaction, but this transaction is still used as collateral for offers to provide capital in the tipping point for at least some embodiments.

Those skilled in the art will appreciate that the consumer experience shown in FIG. 4 can occur in numerous different ways. For example, the consumer could know that they want to support a particular business prior to visiting the portal. In such a case, the step of browsing business profiles (25) could involve a simple search for the business of interest, or could involve selecting a web-link (e.g., URL, QR code, and the like) that leads the consumer to a web page for setting up the promise. In another example of a consumer experience, the step of making a promise (26) could involve signing up for a loyalty program with the business of interest. The loyalty program could be a free loyalty program or could be a paid loyalty program. In the case of a paid loyalty program, the consumer can purchase a loyalty membership in the business of interest at the process point (26). Alternatively, the step of making a promise (26) could involve buying a good or a service.

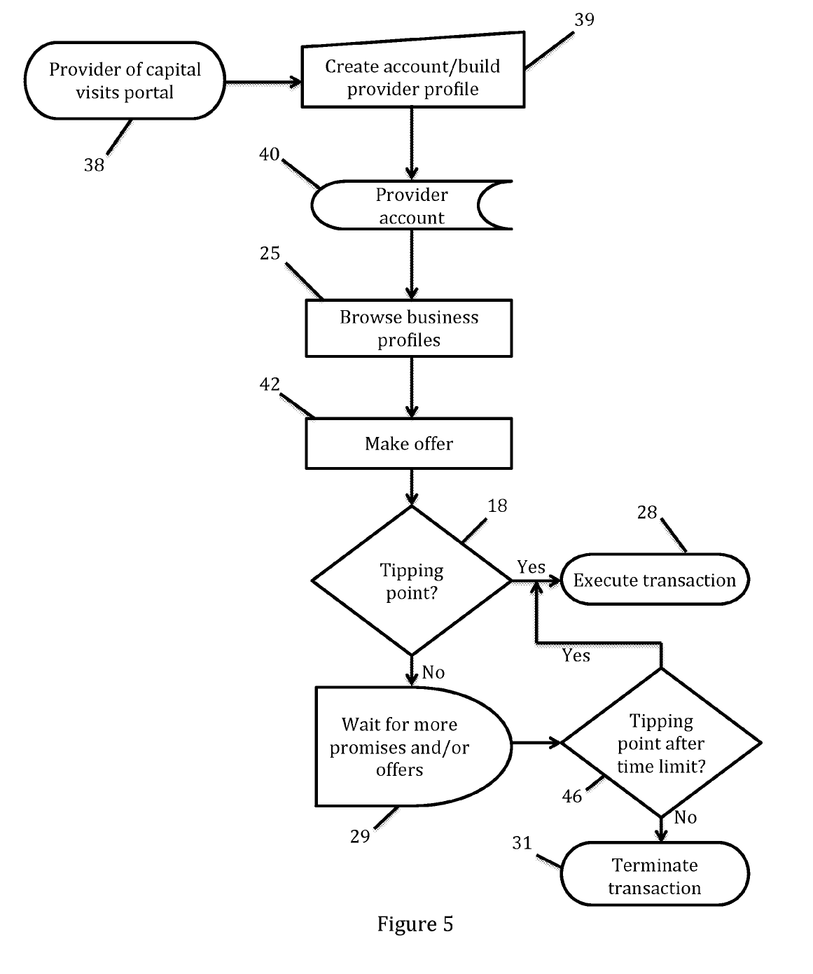

FIG. 5 describes an example of the provider of capital's (or advancer's) interaction in certain embodiments of at least some embodiments. The provider of capital visits the portal (38) and creates an account and/or builds a provider (or advancer) profile (39). It will be understood that the provider/advancer does not need to complete both parts of creating an account and creating a provider profile on the same visit to the portal. After the provider has created a provider account (40), the provider/advancer can browse business profiles (25), or can be provided with certain profiles that match aspects of the provider's profile (e.g., types, locations, financial conditions or years of existence of businesses, or minimal amount of promises/value of promises, or the like) . If a provider advancer finds a business profile of interest for making an offer to provide capital, the provider/advancer can make an offer (42) to provide capital to the business.

In the example shown in FIG. 5, the advancer/provider's offer is pooled with other offers and the computer system connected to the user interface determines whether the tipping point or time has elapsed (18). If neither has occurred, then the advancer/provider waits and more promises and/or offers are received (29). If on the other hand either the time has elapsed or a predetermined tipping is reached (e.g. the total number of offers are received to match the promises to purchase at the predetermined collateralization ratio), then the computer system will execute the transaction (28). A response of “No” for the first decision point (18) allows more time to elapse and more promises and offers to be received until a second decision point (46) is reached where the predetermined time allowed for the campaign has elapsed. At this point, the computer system connected to the user interface determines whether the tipping point was reached (i.e. enough promises and offers were received to execute a transaction). If the output is “No”, then the computer system will terminate transaction (31). If the output is “Yes”, then the computer system will execute transaction (28). It will be understood that several other possibilities exist and are included within the scope of at least some embodiments for the provider/advancer experience. For example, the first decision point (18) may only involve the question of whether the time limit of the campaign to receive offers has expired. If the output is “No” then the provider/advancer waits for the time to expire at the next decision point (46). If the output is “Yes” at the first decision point, then the computer system will execute transaction (28).

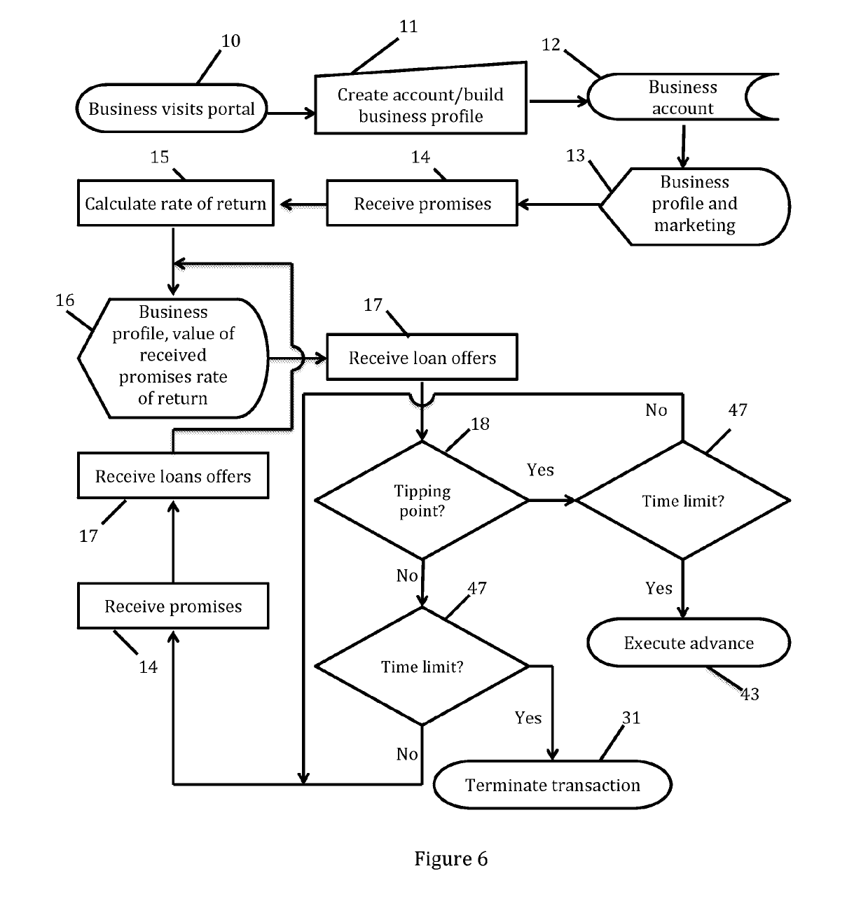

FIG. 6 describes another example of the business experience in certain embodiments of. In this example, the business follows the same steps as described in FIG. 2 up to displaying the business profile and marketing (13). In this example, the display (13) starts a clock for a predetermined time limit of receiving promises to purchase (14). At the end of the predetermined time (e.g. 7-30 days), a computer system connected to the use interface will calculate rate of return (15). The business profile, value of received promises, and rate of return will then be displayed on the user interface (16) and a time clock for receiving loan offers (17) will begin. It will be understood that instead of loan offers, other promises to provide capital (e.g. offer to provide cash in exchange for other financial instruments) can be employed in this example. The time limit for the campaign to receive offers of capital (e.g. loan offers in this example) can be any predetermined time from 1-30 days. Preferably, the time to receive offers can be from 1-7 days. Preferably, the time to receive offers can be from 5-10 days. Preferably, the time to receive offers can be from 7-10 days.

In the example shown in FIG. 6, the decision point (18) asks whether a pre-determined tipping point was reached. If a predetermined tipping point is not reached, the computer system then asks whether the time limit on the funding campaign was reached (47). If the time limit was not reached, then the process goes through a feedback loop to receive promises (14), receive loan offers (17), and display (16). The feedback loop continues until either the decision point (18) is “Yes” and then the following decision point (47) asking whether the time limit has been reached it “Yes”, or decision point (18) is “No” and then the following decision point (47) asking whether the time limit has been reached it “Yes”. In the former case, an execute advance (43) step will be initiated in which the manager provides a cash advance to the business in an amount consistent with the pre-determined tipping point. For example, the tipping point could be a 2:1 ratio of the promises to purchase to offers to lend. In the latter case, the system will execute a terminate transaction (31) process.

If the initial decision point (18) in FIG. 6 is “Yes”, then the computer system will proceed to decision point (47) and ask whether the time limit has been reached. If the answer is “Yes”, then an execute advance (43) step will be initiated in which the manager provides a cash advance to the business in an amount consistent with the pre-determined tipping point. If the answer is “No”, then the process goes through the feedback loop to receive promises (14), receive loan offers (17), and display (16) until the time limit (47) is reached. At that time, the computer system will carry out the execute advance (43) step.

In some preferred embodiments, the manager of the portal will receive information from the consumer, business and provider of capital. The logical processes described herein, or similar variations of the processes described herein, will be followed. If the processes lead to an execute transaction process, then the manager of the portal will create a promissory note with the provider of capital in which the provider of capital gives the manager a set amount of capital in exchange for a promise to repay the amount of capital plus a rate of return (e.g. an interest rate) in a predetermined amount of time. In certain embodiments, the predetermined amount of time is <9 months. In at least one embodiment, the rate of return is <10%. In one embodiment, the promissory note is not a security. In one embodiment, the interest rate is not usury.

In certain embodiments, in addition to the promissory note, the manager of the portal will execute a cash advance to the business in which the business will receive cash in exchange for the assignment of a predetermined percentage of each sale of a costumer that made a promise to purchase, where the repayment includes a premium added to the amount of cash provided to the business. Repayment by the business through a percentage of each sale will continue until the total cash advance plus the premium is repaid. By way of example, if the manager gives a cash advance of $10,000 to a business having 100 customers that have promised to each purchase $200 of goods over the next year and the manager adds a premium of $1000 to the cash advance, then the manager will retain a set percentage of the sales from those 100 customers until the cash advance plus the premium has been repaid. One possible advantage of the collateral of the consumer promises is to be able to lower the cost of the premium in the cash advance because of lower risk of default.

In addition to the cash advance, the manager will also initiate a transaction with the consumer in which the consumer contractually agrees to purchase a predetermined amount of goods of the 1-year period. This contract may be a promise made by the consumer. The contract can be in the form of a membership where the consumer will purchase goods as usual, and every credit card or debit transaction will be subject to the withholding terms of the cash advance until the cash advance plus the premium is repaid. Payments for the promises can be upfront (pre-paid), quarterly, monthly, and the like. Preferably, the membership payment is quarterly. By way of non-limiting example, in the event that a consumer has not purchased the amount of goods equal to their quarterly fee, then the balance of the quarter can be charged to the customer through the manager. In this case the “account” of the consumer at the business will carry a credit for the balance charged until the consumer uses the balance.

Social media and other data associated with a business can also be used to determine how much capital a lender will lend (e.g., at a fraction of monetary value of promises), or to determine the return rate.

It is contemplates that promises from different customers to buy different goods or services of different values may be used to determine the total value of the promises. This is especially true when a business offers different goods or services, and/or when the business offers different prices for the same goods or services depending on the customer, the time of the promise relative to elapsing time or relative to when other promises are made.

Specific systems and methods of providing capital to small businesses through offers to provide capital leveraged by promises to purchase goods or services have been disclosed. It should be apparent, however, to those skilled in the art that many more modifications besides those already described are possible without departing from the inventive concepts herein. The inventive subject matter, therefore, is not to be restricted except in the spirit of the disclosure. Moreover, in interpreting the disclosure, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

### Example Methodologies

Functionality and operation disclosed herein may be embodied as one or more methods implemented by processor(s) at one or more many locations. Non-transitory processor-readable media embodying program instructions adapted to be executed to implement the method(s) are also contemplated. By way of example, not by way of limitation, any number of methods may comprise: receiving data relating to promises by a group of consumers to buy one or more goods or services offered by a business; determining, based on a total cash value of the promises, an amount of capital a lender will lend to the business; and determining, using a computer, one or more payments the lender will receive from the business in exchange for lending the amount of capital to the business.

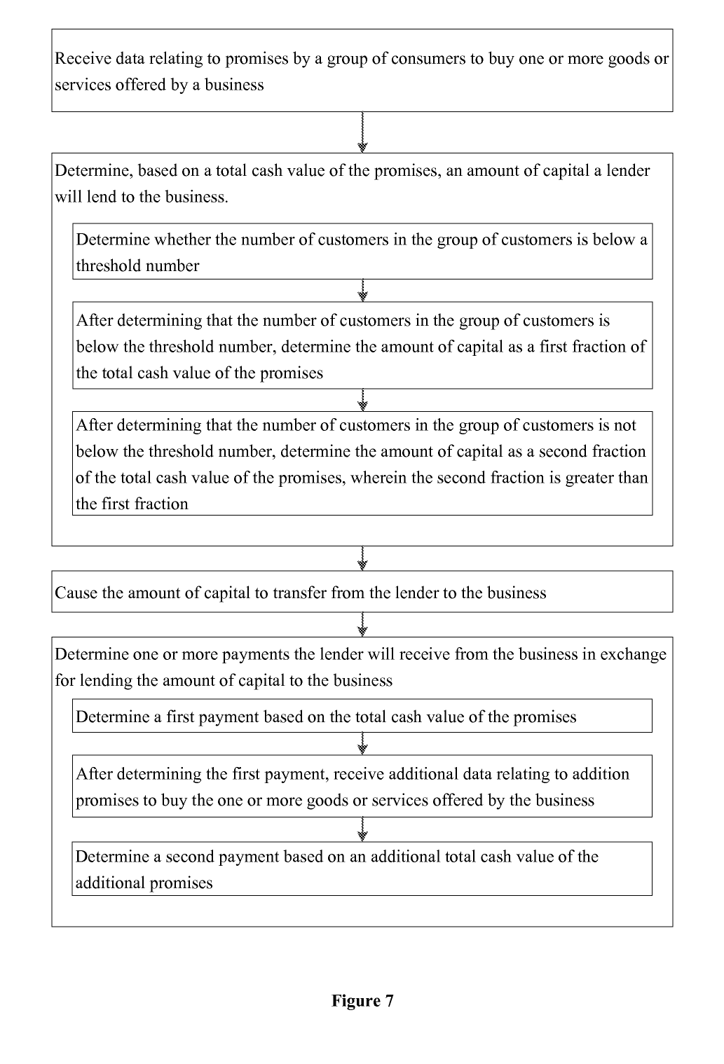

In accordance with some aspects, a first payment is determined based on a first portion of the total cash value of the promises that was spent during a first period of time, and a second payment is determined based on a second portion of the total cash value of the promises that was spent during a second period of time. In accordance with some aspects, the first portion and the second portion correspond to different amounts of the total cash value of the promises, and the first payment and the second payment correspond to different payment amounts. Methods may further or alternatively comprise: determining a first payment based on the total cash value of the promises; after determining the first payment, receiving additional data relating to addition promises to buy the one or more goods or services offered by the business; and determining a second payment based on an additional total cash value of the additional promises. In accordance with some aspects, the first payment is based on a first rate of return, and the second payment is based on a second rate of return that is less than the first rate of return. In accordance with some aspects, the amount of capital is a fraction of the total cash value of the promises. Methods may further or alternatively comprise: determining whether the number of customers in the group of customers is below a threshold number; upon determining that the number of customers in the group of customers is below the threshold number, determining the amount of capital as a first fraction of the total cash value of the promises; and upon determining that the number of customers in the group of customers is not below the threshold number, determining the amount of capital as a second fraction of the total cash value of the promises, wherein the second fraction is greater than the first fraction. In accordance with some aspects, the amount of capital is determined only after a total number of the group of customers exceeds a minimum threshold number. In accordance with some aspects, each of the promises creates a legally-binding obligation on a respective customer to buy a respective amount of the one or more goods or services during a respective period of time. In accordance with some aspects, a first promise obligates a first customer from the group of customers to buy a first amount of the one or more goods or services offered by the business during a first period of time, and a second promise obligates a second customer from the group of customers to buy a second amount of the one or more goods or services offered by the business during a second period of time, wherein the first and second amounts are different and the first and second periods of time are different. In accordance with some aspects, the total cash value of the promises is used as collateral for the amount of capital, wherein the amount of capital is provided to the business from the lender in the form of a cash advance, a promissory note or a loan. Methods may further or alternatively comprise: causing the amount of capital to transfer from the lender to the business. FIG. 7 depicts at least some of aspects of the above methodologies.

It is contemplated that an output from one device may cause another device to perform a method even where the two devices are no co-located (e.g., a receiver in a network of transmitters and a server in another country). Additionally, one or more computers may programmed to carry out various methods, and instructions stored on one or more processor-readable media may be executed by a processor to perform various methods.

### Example System & Other Aspects

At least some embodiments will now be described in detail with reference to several embodiments thereof as illustrated in the accompanying drawings. It is noted that as used herein and in the appended claims, the singular forms “a”, “an”, and “the” include plural referents unless the context clearly dictates otherwise. Furthermore, references to “a” or “an” or “one” or “some” or any stated number of embodiment(s) in this disclosure are not necessarily to the same embodiment(s). In the following description, numerous specific details are set forth in order to provide a thorough understanding of embodiments. It will be apparent, however, to one skilled in the art that embodiments may be practiced without some or all of these specific details. In other instances, well known process steps and/or structures have not been described in detail in order to not unnecessarily obscure the description of at least some embodiments.

It will be understood by one of skill in the art that at least some embodiments may be embodied as a method, a data processing system and/or a computer program or software program. At least some embodiments may use hardware, software, firmware or a combination thereof. Furthermore, at least some embodiments may take the form of a computer program or software on a computer-readable storage medium having computer-readable program commands embodied on the storage medium. Any suitable computer-readable storage medium may be utilized, including hard disks, CD-ROM, optical storage devices, magnetic storage devices, cloud computing systems, and the like. As a computer system, any suitable device for performing computations in accordance with a computer program and/or data storage and retrieval may be used. Examples of such devices include but are not limited a personal computers, a laptop computer, a tablet computer, a smartphone, a microprocessor, a programmable logic device, a field programmable gate array, a discrete signal processor or an application specific circuit. Certain embodiments are described, without limitation, with reference to block diagrams and flowchart illustrations according to various aspects of at least some embodiments. It will be understood that each functional block of the flowchart illustrations can be implemented by computer program instructions. These computer program instructions may be stored on a general use computer, special use computer, or other programmable data processing apparatus to produce a machine, such that the instructions that execute on the computer or other programmable data processing apparatus create may include for implementing the functions specified in the flowchart block or blocks. Computer program instructions may also be stored in a computer-readable memory that can direct a computer or other programmable data processing apparatus to function in a particular manner, such that the instructions stored in the computer-readable memory produce system that implements the function specified in the flowchart block or blocks. The computer program instructions may also be loaded onto a computer or other programmable data processing apparatus to cause a series of operational steps to be performed on the computer or other programmable data processing apparatus to produce a computer-implemented process such that the instructions that execute on the computer or other programmable data processing apparatus provide steps for implementing the functions specified in the flowchart block or blocks. One skilled in the art will appreciate that, for a myriad of reasons including security reasons, any databases, systems, or components of at least some embodiments may consist of any combination of databases or components at a single location or at multiple locations, wherein each database or system may include any of various suitable security features, such as firewalls, access codes, encryption, de-encryption, compression, decompression, or the like.

Systems may include one or more devices or means that implement the functionality (e.g., embodied as methods) described herein. For example, such devices or means may include processor(s) that, when executing instructions, perform any of the methods disclosed herein. Such instructions can be embodied in software, firmware and/or hardware. A processor (also referred to as a “processing device”) may perform or otherwise carry out any of the operational steps, processing steps, computational steps, method steps, or other functionality disclosed herein, including analysis, manipulation, conversion or creation of data, or other operations on data. A processor may include a general purpose processor, a digital signal processor (DSP), an integrated circuit, a server, other programmable logic device, or any combination thereof. A processor may be a conventional processor, microprocessor, controller, microcontroller, or state machine. A processor can also refer to a chip or part of a chip (e.g., semiconductor chip). The term “processor” may refer to one, two or more processors of the same or different types. It is noted that a computer, computing device and user device, and the like, may refer to devices that include a processor, or may be equivalent to the processor itself. A “memory” may accessible by a processor such that the processor can read information from and/or write information to the memory. Memory may be integral with or separate from the processor. Instructions may reside in such memory (e.g., RAM, flash, ROM, EPROM, EEPROM, registers, disk storage), or any other form of storage medium. Memory may include a non-transitory processor-readable medium having processor-readable program code (e.g., instructions) embodied therein that is adapted to be executed to implement any number of the various methods disclosed herein. Processor-readable media be any available storage media, including non-volatile media (e.g., optical, magnetic, semiconductor). Functionality disclosed herein may be programmed into any of a variety of circuitry that is suitable for such purpose as understood by one of skill in the art. For example, functionality may be embodied in processors having software-based circuit emulation, discrete logic, custom devices, neural logic, quantum devices, PLDs, FPGA, PAL, ASIC, MOSFET, CMOS, ECL, polymer technologies, mixed analog and digital, and hybrids thereof. Data, instructions, commands, information, signals, bits, symbols, and chips disclosed herein may be represented by voltages, currents, electromagnetic waves, magnetic fields or particles, optical fields or particles, or any combination thereof. Computing networks may be used to carry out functionality and may include hardware components (servers, monitors, I/O, network connection). Application programs may carry out aspects by receiving, converting, processing, storing, retrieving, transferring and/or exporting data, which may be stored in a hierarchical, network, relational, non-relational, object-oriented, or other data source. A data source that is depicted as a single storage device may be realized by multiple (e.g., distributed) storage devices. A data source may include one or more types of data sources, including hierarchical, network, relational, non-relational, object-oriented, or another type of data source. As used herein, computer-readable media includes all forms of computer-readable medium except, to the extent that such media is deemed to be non-statutory (e.g., transitory propagating signals). The various illustrative systems, methods, logical features, blocks, modules, components, circuits, and algorithm steps described herein may be implemented, performed, or otherwise controlled by suitable hardware known or later developed in the art, or by firmware or software executed by processor(s), or any such combination of hardware, software and firmware. Features in system and apparatus figures that are illustrated as rectangles may refer to hardware, firmware or software. It is noted that lines linking two such features may be illustrative of data transfer between those features. Such transfer may occur directly between those features or through intermediate features even if not illustrated. Where no line connects two features, transfer of data between those features is contemplated unless otherwise stated. Accordingly, the lines are provide to illustrate certain aspects, but should not be interpreted as limiting.

1. A computer-implemented method for facilitating capital lending based on consumer promises, the method comprising:
receiving data relating to promises by a group of consumers to buy one or more goods or services offered by a business;
determining, based on a total cash value of the promises, an amount of capital a lender will lend to the business; and
determining, using a computer, one or more payments the lender will receive from the business in exchange for lending the amount of capital to the business.

2. The method of claim 1, wherein a first payment is determined based on a first portion of the total cash value of the promises that was spent during a first period of time, and a second payment is determined based on a second portion of the total cash value of the promises that was spent during a second period of time.

3. The method of claim 2, wherein the first portion and the second portion correspond to different amounts of the total cash value of the promises, and wherein the first payment and the second payment correspond to different payment amounts.

4. The method of claim 1, the method further comprising:
determining a first payment based on the total cash value of the promises;
after determining the first payment, receiving additional data relating to addition promises to buy the one or more goods or services offered by the business; and
determining a second payment based on an additional total cash value of the additional promises.

5. The method of claim 4, wherein the first payment is based on a first rate of return, and the second payment is based on a second rate of return that is less than the first rate of return.

6. The method of claim 1, wherein the amount of capital is a fraction of the total cash value of the promises.

7. The method of claim 6, the method further comprising:
determining whether the number of customers in the group of customers is below a threshold number;
upon determining that the number of customers in the group of customers is below the threshold number, determining the amount of capital as a first fraction of the total cash value of the promises; and
upon determining that the number of customers in the group of customers is not below the threshold number, determining the amount of capital as a second fraction of the total cash value of the promises, wherein the second fraction is greater than the first fraction.

8. The method of claim 1, wherein the amount of capital is determined only after a total number of the group of customers exceeds a minimum threshold number.

9. The method of claim 1, wherein each of the promises creates legally-binding obligation on a respective customer to buy a respective amount of the one or more goods or services during a respective period of time.

10. The method of claim 1, wherein a first promise obligates a first customer from the group of customers to buy a first amount of the one or more goods or services offered by the business during a first period of time, and wherein a second promise obligates a second customer from the group of customers to buy a second amount of the one or more goods or services offered by the business during a second period of time, wherein the first and second amounts are different and the first and second periods of time are different.

11. The method of claim 1, wherein the total cash value of the promises is used as collateral for the amount of capital, wherein the amount of capital is provided to the business from the lender in the form of a cash advance, a promissory note or a loan.

12. The method of claim 1, wherein the method further comprises:
causing the amount of capital to transfer from the lender to the business.

13. A system for facilitating capital lending based on consumer promises, the system comprising at least one processor that:
receives data relating to promises by a group of consumers to buy one or more goods or services offered by a business;
determines, based on a total cash value of the promises, an amount of capital a lender will lend to the business; and
determines one or more payments the lender will receive from the business in exchange for lending the amount of capital to the business.

14. The system of claim 13, wherein a first payment is determined based on a first portion of the total cash value of the promises that was spent during a first period of time, and a second payment is determined based on a second portion of the total cash value of the promises that was spent during a second period of time.

15. The system of claim 14, wherein the first portion and the second portion correspond to different amounts of the total cash value of the promises, and wherein the first payment and the second payment correspond to different payment amounts.

16. The system of claim 13, wherein the processor:
determines a first payment based on the total cash value of the promises;
after determining the first payment, receives additional data relating to additional promises to buy one or more goods or services offered by the business; and determines a second payment based on an additional total cash value of the additional promises.

17.-24. (canceled)

25. A non-transitory machine-readable medium embodying program instructions adapted to be executed to implement a method for facilitating capital lending based on consumer promises, the method comprising:
receiving data relating to promises by a group of consumers to buy one or more goods or services offered by a business;
determining, based on a total cash value of the promises, an amount of capital a lender will lend to the business; and
determining, using a computer, one or more payments the lender will receive from the business in exchange for lending the amount of capital to the business.

26. The non-transitory computer-readable medium of claim 25, wherein a first payment is determined based on a first portion of the total cash value of the promises that was spent during a first period of time, and a second payment is determined based on a second portion of the total cash value of the promises that was spent during a second period of time.

27. The non-transitory computer-readable medium of claim 26, wherein the first portion and the second portion correspond to different amounts of the total cash value of the promises, and wherein the first payment and the second payment correspond to different payment amounts.

28. The non-transitory computer-readable medium of claim 25, the method further comprising:
determining a first payment based on the total cash value of the promises;
after determining the first payment, receiving additional data relating to addition promises to buy the one or more goods or services offered by the business; and
determining a second payment based on an additional total cash value of the additional promises.

29.-36. (canceled)
